(19) United States
(12) Patent Application Publication
(10) Pub. No.: US 2023/0141568 A1
(43) Pub. Date: May 11, 2023

(54) DOOR ASSEMBLY WITH RECHARGEABLE ELECTRICAL POWER SUPPLY FOR INTEGRATED ELECTRIC DEVICES AND METHODS THEREOF

(71) Applicant: Masonite Corporation, Tampa, FL (US)

(72) Inventors: Satishkumar SIVASANKARAN, Aurora, IL (US); Alex BODURKA, Portage, MI (US); Navid ANDALIBI-ABADAN, Glen Ellyn, IL (US)

(21) Appl. No.: 17/982,268

(22) Filed: Nov. 7, 2022

Related U.S. Application Data
(60) Provisional application No. 63/276,060, filed on Nov. 5, 2021.

(51) Int. Cl. E06B 7/28; E06B 5/10; E05B 47/00

(52) U.S. Cl. CPC E06B 7/28; E06B 5/10; E05B 47/0001; H02J 50/12

(57) ABSTRACT

Aspects of the present disclosure describe a rechargeable door that includes at least one internal rechargeable battery and at least one further DC component powered by such rechargeable battery, wherein the at least one internal rechargeable battery is configured to be recharged via a physical connection, such as wired connections, or other contacts such as magnetic contacts or pogo pins or spring contacts, in the door via a second rechargeable battery or via wireless recharging, for example magnetic inductive or resonance charging, via placement of the second rechargeable battery on or within the door.

### CROSS-REFERENCE TO RELATED APPLICATIONS

This application claims the benefit of U.S. Provisional Application Ser. No. 63/276,060, filed Nov. 5, 2021, the disclosure of which is incorporated herein by reference in its entirety.

### FIELD

The present technology is directed to exterior or interior doors for residential or commercial buildings, such as for a home, apartment, condominium, hotel room or business, and more particularly to a door assembly provided with a rechargeable source of electrical power to provide power to operate electric devices mounted to the door assembly.

### BACKGROUND

Typical existing exterior or interior doors for residential or commercial buildings may have a number of electric devices (or components) mounted to the doors in order to provide desired functions, such as electronic access control, door state feedback, an entry camera and audio communication, an electric powered door latch, an electric powered door lock, etc. Also, the market for exterior and interior doors has seen an increasing adoption of additional electric devices including video doorbells, smart locks, LED lighting, smart glass, electromechanical door closers, wireless connectivity electronics, etc. Each of these discrete electric devices typically is an add-on to or near an existing door, functions with the existing door construction, and is powered separately with at least one battery that requires periodic replacement or charging. Should the battery not be replaced or recharged, then the electric device will not operate.

Current electric devices are mounted to exterior or interior doors in a manner that can be unattractive and unpleasant to look at. The electric devices typically each have either one or more rechargeable battery packs or at least one non-rechargeable battery that must periodically be recharged or changed and have some type of weatherable housing that may not match the appearance of the door. The need for multiple different battery packs and different kinds of batteries, each for a different electrical device renders the power management for those different batteries difficult and cumbersome to manage.

It has been proposed that AC line current be supplied to power a door in order to enhance electric operating capability of a door, such as to power accessories, such as electric door locks, electric cameras, electric latches and the lock. While providing AC power for new construction projects is possible, providing AC power in after market, rehabilitation, or remodeling projects can create scheduling issues, increase component costs, including costs for building in and connecting AC power to existing walls and outer door frames and other issues due to the various crafts that are required.

Therefore, there exists a need for a door and methods of operation designed for integration of electric devices into the door, with electrical power provided from a single battery source without adversely impacting structural integrity, insulation and/or acoustic performance, energy efficiency, and aesthetics of the door, and without the need to retrofit existing walls and exterior door frames with AC power.

### SUMMARY

The present disclosure generally relates to exterior or interior doors for residential or commercial buildings, such as for a home, apartment, condominium, hotel room or business, and more particularly to a door assembly provided with a rechargeable source of electrical power to provide power to operate electric devices mounted to the door assembly. Exemplary embodiments provide a door that includes: a door slab, including a rectangular inner door frame; a first facing or skin secured to or formed on a first rectangular side of the inner door frame; a second facing or skin secured to or formed on a second, opposite rectangular side of the inner door frame; at least one hinge portion or point of attachment configured to affix to a corresponding hinge portion or point of attachment on or within a separate outer door frame; wherein the rectangular inner door frame includes at least one hollow cavity housing a plurality of at least partially internal components, the components including plural direct current (DC) electrical devices, including: at least one internal rechargeable battery; and at least one device selected from the group comprising: an electronic access control; a door state sensor; an entry camera with video; an audio communication unit; an audio or video doorbell; a digital camera; a light; a motion detector or sensor; a proximity sensor; a door opener; heating and cooling thermostat controls; alarm sensor or controls; lighting; household or automobile batteries; or automotive controls; wherein the at least one internal rechargeable battery is configured to power the at least one device, and wherein the at least one internal rechargeable battery is configured to be recharged by at least one further rechargeable battery that is placed in wired or wireless proximity to the at least one rechargeable battery.

In exemplary aspects described herein, such a door may advantageously retrofit to existing door construction without the need to replace components or otherwise provision AC power supply to the door itself.

In further exemplary embodiments, the door components further include a charging circuit interposed between the at least one internal rechargeable battery and the at least one further rechargeable battery.

In further exemplary embodiments, the door slab includes at least one user interface or low battery notification module.

In further exemplary embodiments, the at least one further rechargeable battery is configured to recharge the at least one internal rechargeable battery via magnetically mounted locations, with at least one magnet positioned in the door and at least one corresponding magnet mounted in the at least one further rechargeable battery. In the event that such magnetically mounted location utilizes magnetic connections for power transfer/charging/recharging, then plural magnetic connections may be provided, e.g., at least one for a positive (+) and one for a ground (−) connection to provide for that power transfer.

In further exemplary embodiments, plural magnets are provided within the door slab proximate a wireless recharging module in the door slab.

In further exemplary embodiments, the at least one further rechargeable battery is configured to recharge the at least one internal rechargeable battery via a physical connection.

In further exemplary embodiments, the physical connection includes plural pogo pins or spring contacts.

In further exemplary embodiments, the physical connection that is configured to recharge the at least one internal rechargeable battery is also a magnetic connection configured to mount the at least one further rechargeable battery.

In further exemplary embodiments, the at least one further rechargeable battery is configured to wireless recharge the at least one internal rechargeable battery via an inductive or resonance charge system.

In further exemplary embodiments, the inductive or resonance charge system includes at least one power receiver configured to receive power from an inductive or resonant power transmitter, within a minimal proximity between the receiver and the transmitter.

In further exemplary embodiments, the at least one rechargeable battery is configured to fit in a pre-configured recess in the door slab corresponding to the shape of at least one other door or facing shape.

In further exemplary embodiments, the at least one further rechargeable battery is configured to recharge the at least one internal rechargeable battery via a mounted location, with at least one physical connector in the door and at least one slot or interference fit mount on the at least one further rechargeable battery.

In further exemplary embodiments, the at least one further rechargeable battery is configured to recharge the at least one internal rechargeable battery via a door slab mounted recharge connector, with at least one physical connector in the door configured within at least one slot or on an interference fit mount on or within the door slab.

Additional exemplary embodiments relate to door systems and methods of charging a door in accordance with the above and additional exemplary embodiments described herein.

The details of one or more aspects of the disclosure are set forth in the accompanying drawings and the description below. Other features, objects, and advantages of the techniques described in this disclosure will be apparent from the description and drawings, and from the claims.

### BRIEF DESCRIPTION OF THE DRAWINGS

FIG. 1 is an elevational exterior view of a door system;

FIG. 2 is an elevational interior view of the door system;

FIG. 3 is an elevational view of the door system according to an embodiment of the present invention without an exterior door skin in order to allow observation of the interior of the door;

FIG. 4 is a block diagram showing a first embodiment of the rechargeable power supply;

FIG. 5 is a perspective view of the door having a battery pack inserted therein;

FIG. 6 is an enlarged view of the battery pack shown in FIG. 5;

FIG. 7 is an enlarged view of the battery pack having a cylindrical shape;

FIG. 8 is a block diagram showing a second embodiment of the rechargeable power supply;

FIG. 9 is a perspective view of the door having a rectangular battery pack attached to its door skin;

FIG. 10 is the same view as FIG. 9 showing the hidden internal battery inside the door;

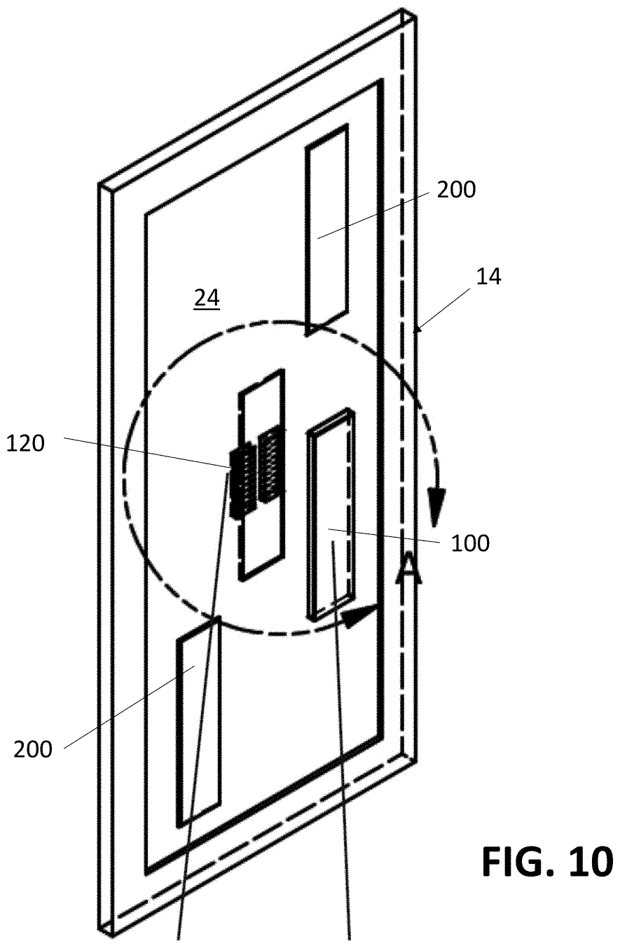

FIG. 11 is an enlarged view of the circled portion of FIG. 10;

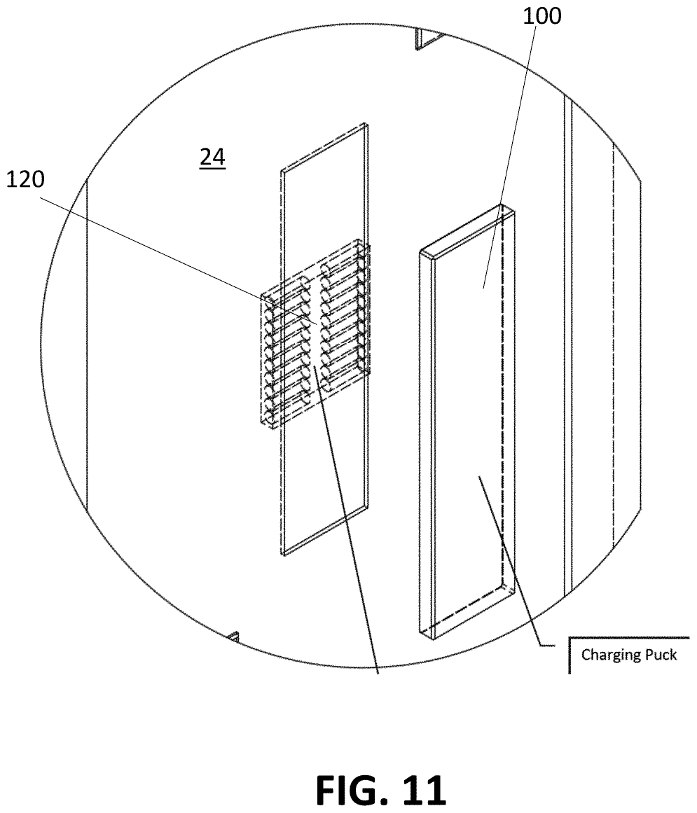

FIG. 12 is a perspective view of the door having a circular puck battery pack attached to its door skin; and

FIG. 13 is a flow chart of an exemplary method in accordance with the present disclosure

### DETAILED DESCRIPTION

Reference will now be made in detail to the exemplary embodiments and exemplary methods as illustrated in the accompanying drawings, in which like reference characters designate like or corresponding parts throughout the drawings. It should be noted, however, that the invention in its broader aspects is not necessarily limited to the specific details, representative materials and methods, and illustrative examples shown and described in connection with the exemplary embodiments and exemplary methods.

This description of exemplary embodiments is intended to be read in connection with the accompanying drawings, which are to be considered part of the entire written description. In the description, relative terms such as “horizontal,” “vertical,” “front,” “rear,” “upper”, “lower”, “top” and “bottom” as well as derivatives thereof (e.g., “horizontally,” “vertically,” “downwardly,” “upwardly,” etc.) should be construed to refer to the orientation as then described or as shown in the drawing figure under discussion and to the orientation relative to a vehicle body. These relative terms are for convenience of description and normally are not intended to require a particular orientation. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise. The term “operatively connected” is such an attachment, coupling or connection that allows the pertinent structures to operate as intended by virtue of that relationship. The term “integral” (or “unitary”) relates to a part made as a single part, or a part made of separate components fixed (i.e., non-moveable) and connected together. Additionally, the word “a” and “an” as used in the claims means “at least one” and the word “two” as used in the claims means “at least two.”

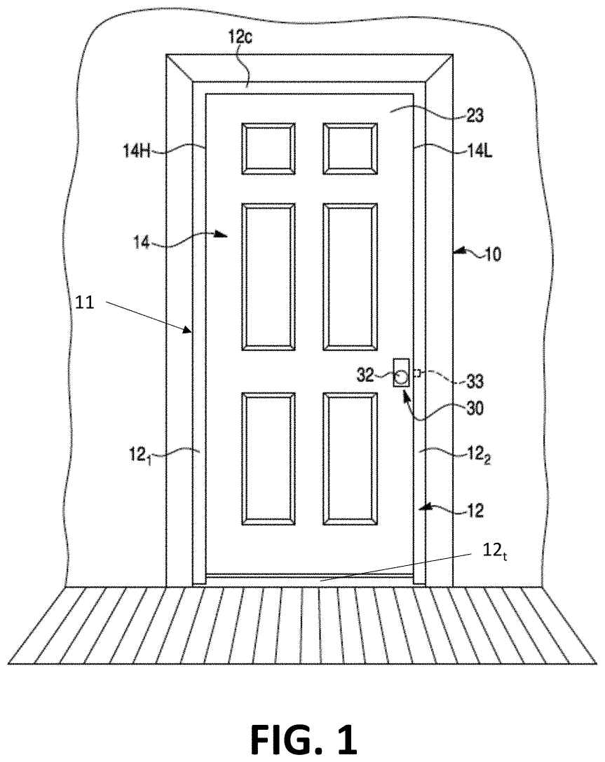

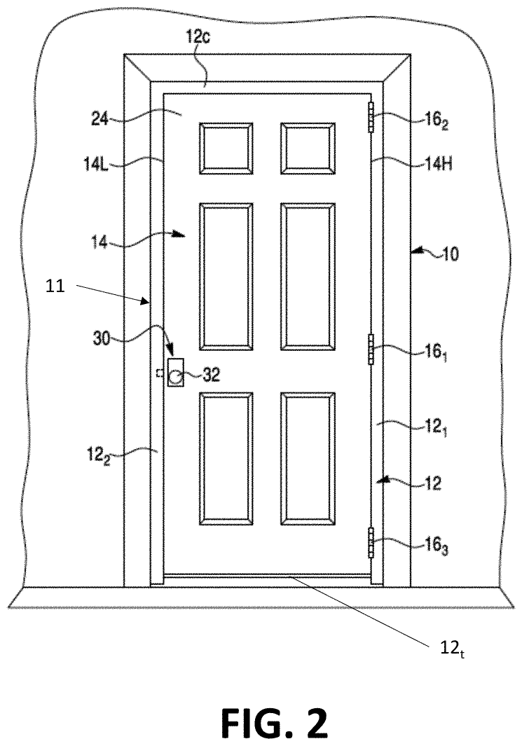

FIGS. 1 and 2 illustrate a door system ten according to an exemplary embodiment of the present invention, such as a pre-hung door. The illustrated, exemplary door system 10 includes a conventional hinged residential exterior door assembly 11, but it should be understood that the door assembly 11 may be a pivotally mounted exterior or interior door assembly provided for a residential or commercial building, such as a home, apartment, garage, condominium, hotel, office building, or the like, or a door with alternate door to exterior frame connections, such as a door hanging on a rail, etc. The door assembly 11 may be made of any appropriate material, such as wood, metal, wood composite material, fiberglass reinforced polymer composite or the like. The illustrated, exemplary door assembly 11 includes a substantially rectangular door frame 12 and a door 14 pivotally attached thereto by at least one hinge 16₁, such as a “butt hinge” that includes two leaves.

The illustrated door frame 12 includes first and second parallel, spaced apart vertically extending jamb members 12₁, 12₂ and a horizontally extending upper jamb rail member or header 12c that connects upper ends of the first and second jamb members 12₁, 12₂. Those skilled in the art recognize that lower ends of the jamb members 12₁, 12₂ may be interconnected through a threshold 12ₜ. The at least one hinge 16₁ pivotally attaches the door 14 to the first jamb member 12₁. Typically, at least two hinges 16₁ and 16₂ are provided to secure the door 14 to the first jamb member 12₁. Preferably, as best shown in FIG. 2, three hinges 16₁, 16₂, 16₃ are used to secure the door 14 to the door frame 12. In the interest of simplicity, the following discussion will sometimes use a reference numeral 16 without a subscript numeral to designate an entire group of the hinges. For example, the reference numeral 16 will be sometimes used when generically referring to the hinges 16₁, 16₂ and 16₃. The same is also true from the door frame 12 which comprises the jambs 12₁, 12₂, and the header 12_{c} (some frame 12 may also include a threshold 12ₜ.

The illustrated door 14 includes a rectangular inner door frame 20, an exterior door skin (or facing) 23, and an interior door skin (or facing) 24 secured to opposite sides of the inner door frame 20, as best shown in FIGS. 1-3. The exterior and interior door skins 23 and 24 are formed separately from one another, and typically are identical in appearance, though it should be noted that the present disclosure contemplates door facings or skins that are more generally secured to or integral with the door 14. The door skins 23 and 24 are secured, e.g., typically adhesively, to a suitable core and/or to opposite sides of the inner door frame 20 so that the inner door frame 20 is sandwiched between the exterior and interior door skins 23 and 24. In exemplary embodiments, the exterior and interior door skins 23 and 24 are made of a polymer-based composite, such as sheet molding compound (“SMC”) or medium-density fiberboard (MDF), other wood composite materials, fiber-reinforced polymer, such as fiberglass, hardboard, fiberboard, steel, and other thermoplastic materials. The door 14 has a hinge side 14H mounted to the inner door frame 20 by the hinges 16, and a horizontally opposite latch side 14L.

The inner door frame 20 includes a pair of parallel, spaced apart horizontally extending top and bottom rails 21₁and 21₂, respectively, and a pair of parallel, spaced apart vertically extending first (lock side) and second (hinge side) stiles 22₁ and 22₂, respectively, typically manufactured from wood or an engineered wood, such as a laminated veneer lumber (LVL). The top and bottom rails 21₁ and 21₂ horizontally extend between the first and second stiles 22₁ and 22₂. Moreover, the top and bottom rails 21₁ and 21₂ may be fixedly secured to the first and second stiles 22₁ and 22₂, such as through adhesive or mechanical fasteners. The inner door frame 20 further may include a mid-rail (not shown). The mid-rail extends horizontally and is spaced apart from the top and bottom rails 21₁ and 21₂, respectively, and is typically also manufactured from wood or an engineered wood, such as a laminated veneer lumber (LVL). Moreover, the mid-rail may be fixedly secured to the first and second stiles 22₁ and 22₂. The hinges 16 are secured to the first stile 22₁, which define a hinge stile of the inner door frame 20.

The inner door frame 20 and the exterior and interior door skins 23, 24 of a typical door 14 surround an interior cavity, which may be hollow or may be filled with, for example, corrugated pads, foam insulation, or other core materials, if desired. Thus, the door 14 may include a core 15 disposed within the inner door frame 20 between the exterior and interior door skins 23 and 24. The core 15 may be formed from foam insulation, such as polyurethane foam material, cellulosic material and binder resin, corrugated pads, etc. While a door 14 is described in exemplary embodiments as having a frame 20 with skins 23, 24 and an interior cavity, exemplary embodiments of the present disclosure contemplate any door construction that includes at least one hollow interior space, as will be described in more detail below, at least partially housing plural interior DC components, including an internal rechargeable battery and at least one additional of a plurality of possible DC components described herein.

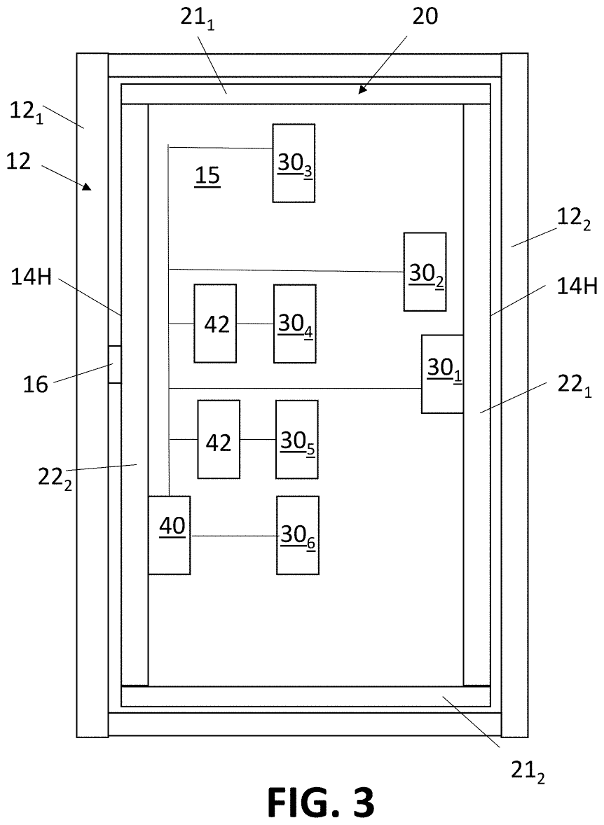

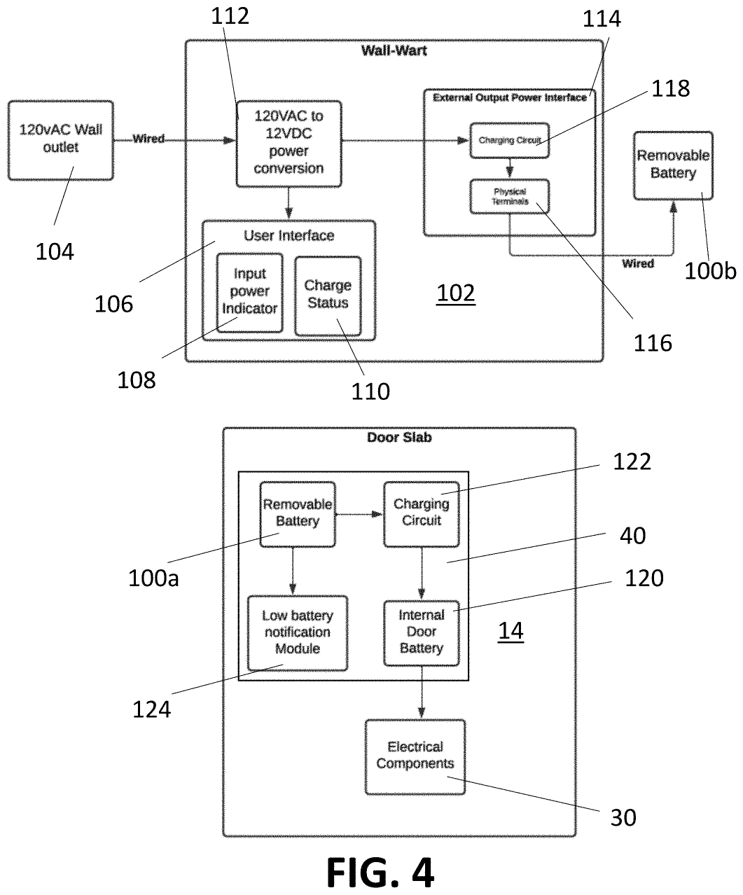

As shown in FIGS. 3-4, in the illustrated exemplary embodiment, the door system 10 includes at least one of a number of possible direct current (DC) electrical devices 30 mounted to or at least partially housed within the door 14 of the door system 10 to provide functions, such as electronic access control, door state feedback, entry camera and audio/video communication, etc. Specifically, the electrical devices 30 that may be mounted to the door system 10 include, but are not limited to, an electric powered door latch 30₁, a doorbell 30₂, a digital camera 30₃, a light 30₄, a motion detector 30₅ (or motion sensor), a proximity sensor 30₆, as best illustrated in FIG. 3. Specifically, the electric powered door latch 30₁ may be mounted to the inner door frame 20 of the door 14, while the doorbell 30₂, the digital camera 30₃ and the light 30₄ may be mounted to the door 14 of the door system 10, as best illustrated in FIG. 3. Although FIG. 3 shows the electrical devices 30, their positions on the drawings are representative and are not intended to be fixed. The position of the electrical devices 30 on the door 14 may vary significantly from the positions shown in FIGS. 3-4. It should be understood that the door system 10 may include electric devices other than the electric powered door latch 30₁, the doorbell 30₂, the digital camera 30₃, the light 30₄, the motion detector 30₅, the proximity sensor 30₆, as there are a number of electric devices marketed to be mounted to doors and provide functions such as electronic access control, door state feedback, entry camera and communication, etc. In the interest of simplicity, the following discussion will sometimes use a reference numeral without a subscript numeral to designate an entire group of the electric devices. Herein, the reference numeral 36 used when generically referring to the electrical devices 30₁-30₆ and/or other electrical devices.

In exemplary embodiments, the electrical devices 30 typically are low-voltage DC electric devices operated by low-voltage DC electrical power. Low voltage direct current (DC) is known in the art as 50 volts (V) or less. Common low voltages are 1.8 V, 3.3 V, 5 V, 12 V, 24 V, and 48 V. Low voltage is normally used for doorbells, video doorbells, garage door opener controls, heating and cooling thermostats, alarm system sensors and controls, outdoor ground lighting, household and automobile batteries. Many DC electric devices operate at 5 V DC. Low voltage (when the source is operating properly), such as 5 V DC, will not provide a shock from contact. However, a high current, low voltage short circuit (automobile battery) can cause an arc flash and possibly burns.

As illustrated in FIGS. 3-4, the illustrated, exemplary door 14 further includes a rechargeable power source 40 to provide electrical power to the electrical devices 30. In exemplary embodiments, the rechargeable power source 40 is a rechargeable battery pack that is mounted inside or at least partially housed within an interior space of the door 14, such as attached to a hinge side stile 22₂, and is electrically connected through an electrical distribution system to the electrical devices 30. In certain embodiments, one or more of the electrical devices 30 may be connected to the rechargeable power source 40 via a controller 42 to provide the proper operating voltage to the particular electrical device 30. For example, as illustrated in FIG. 3, the light 30₄ and the motion detector 30₅ are connected to the rechargeable power source 40 via the controller 42, while the door latch 30₁, the doorbell 30₂, are connected directly with the source 40. It should be understood that FIG. 3 illustrates an exemplary embodiment and that the electrical connection between the individual electrical devices 30 and the rechargeable power source 40 correspond with the power requirement of that electrical device 30.

In exemplary embodiments, the rechargeable power source 40 includes a rechargeable battery pack 120 and a removable rechargeable battery pack 100. In a first exemplary embodiment, as illustrated in FIG. 4, the door system 10 is provided with multiple removable rechargeable battery packs 100, for example at least two (shown in FIGS. 4 as 100a and 100b). The rechargeable battery pack 100 may be removeable from the door 14, e.g., via an opening in the door 14, to be recharged at a remote charging station 102.

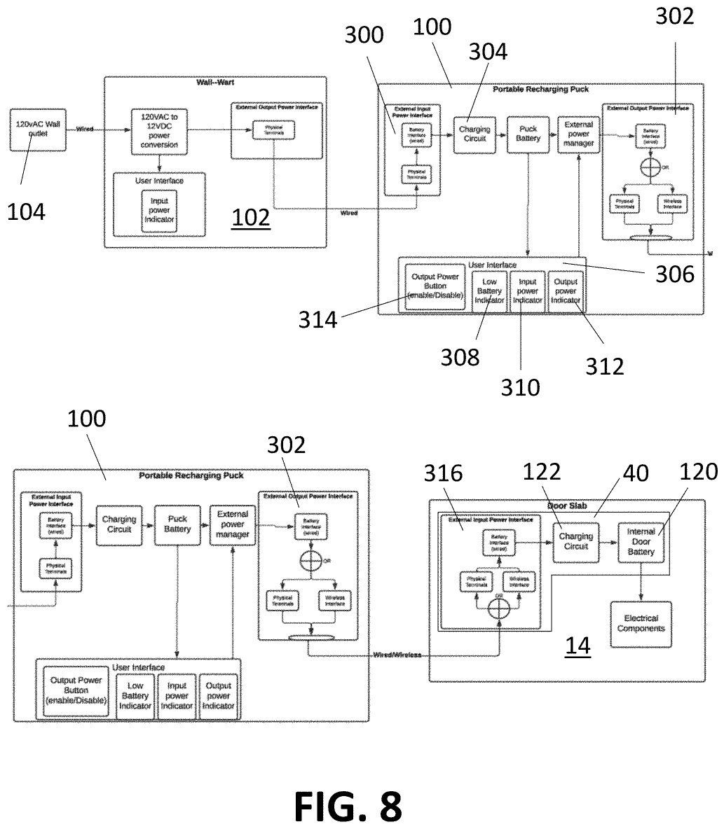

FIG. 4 shows an exemplary configuration for the charging station 102 and the rechargeable power source 40. The charging station 102 is electrically connected to an alternating current (AC) power source 104. The AC power source 104 may be a standard 120 (or 110) volts general-purpose AC electrical power supply known in the USA as grid power, wall power, or domestic power. Other voltages, such as 220 volts, may also be used. The AC power source 104 provides electrical power to the charging station 102 for charging the removable battery pack 100. The charging station 102 preferably includes an AC to direct current (DC) converter 112 which rectifies the AC to provide DC for charging the battery pack 100. The charging station 102, in exemplary embodiments, also includes a user interface 106 which contains an input power indicator 108 and charging status indicator 110. The input power indicator 108 may be, e.g., a light or LED showing whether the charging station 102 is electrically connected to the AC power source 104; and the charge status indicator 110 is preferably one or more lights or LEDs showing the charging status of the battery 100 (whether the battery is fully charged or still being charged). In certain embodiments, the user interface 106 and/or the charging circuit 118 may be located on the rechargeable battery pack 100 (e.g., as shown in FIG. 8), instead of the charging station 102. The DC from the AC to DC converter 112 (note that while FIGS. 4 and 8 show exemplary 120 VAC to 12 VDC converter, any conversion is contemplated (e.g., to 5 V DC, etc. or otherwise) as is further described in the descriptions of the various embodiments herein) is routed to the power interface 114 to charge the battery 100. The battery 100 may be connected to the power interface 114 to make electrical connection with electrical terminals 116 on the power interface 114. The exemplary illustrated power interface 114 also include a charging circuit 118 to control and regulate the charging of the battery pack 100.

In exemplary methods, the charged battery pack 100 may be inserted into the door to provide additional power to the power source 40. The exemplary power source 40, as shown in FIG. 4, includes an internal battery 120 that is built into or at least partially housed within the door 14 and, in exemplary embodiments, is not easily removable. The internal battery 120 receives power from and is kept charged by the battery pack 100 via a charging circuit 122. The internal battery 120 allows the door to operate when the removable battery 100 is removed from the system to be recharged.

In exemplary embodiments, the power source 40 also includes a low battery indicator 124 to monitor the power status of the battery pack 100 to warn the user that the battery pack 100 is low on power and needs to be replaced and recharged. When the battery pack 100 is indicated as being low, the user removes the battery pack 100 from the door 14 and replaces it with a freshly charged battery pack 100. The removed battery pack 100 is then recharged at the charging station 102 to be used at a later time to replace the battery pack 100 that is then being used in the door 14.

In exemplary embodiments where only one removable battery pack 100 is available, the exemplary door system 10 and associated electrical components 30 can be configured to be fully operational due to the presence of the internal battery 120, even in the absence of the removable battery pack 100 (e.g., while it is recharging).

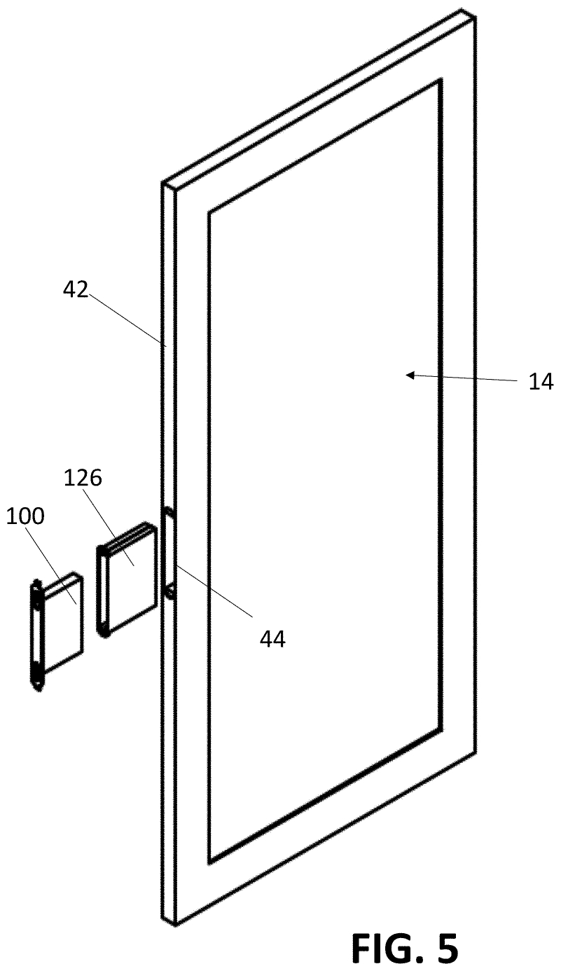

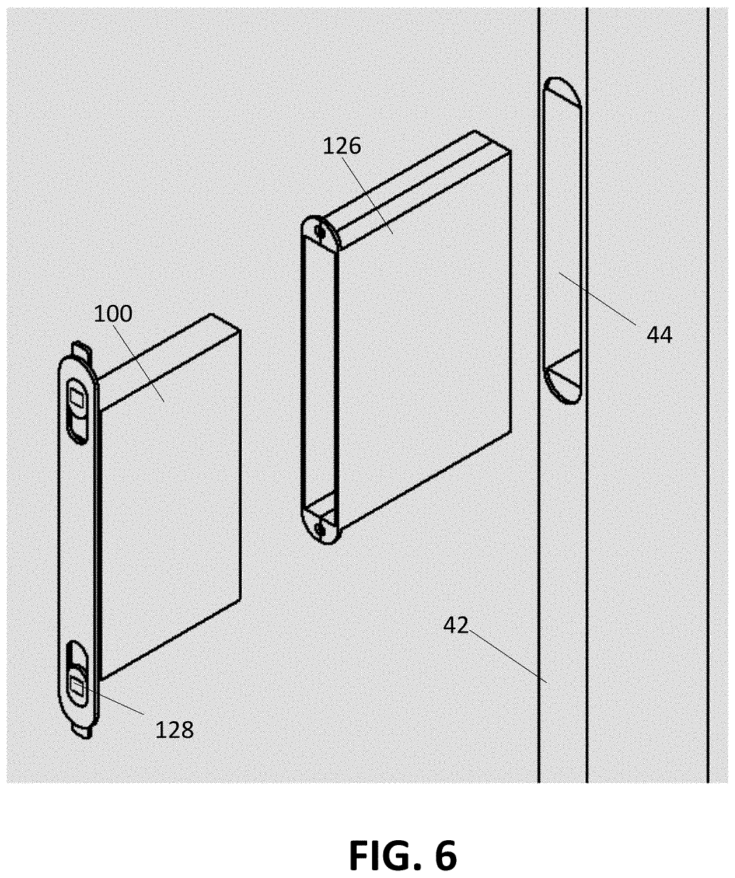

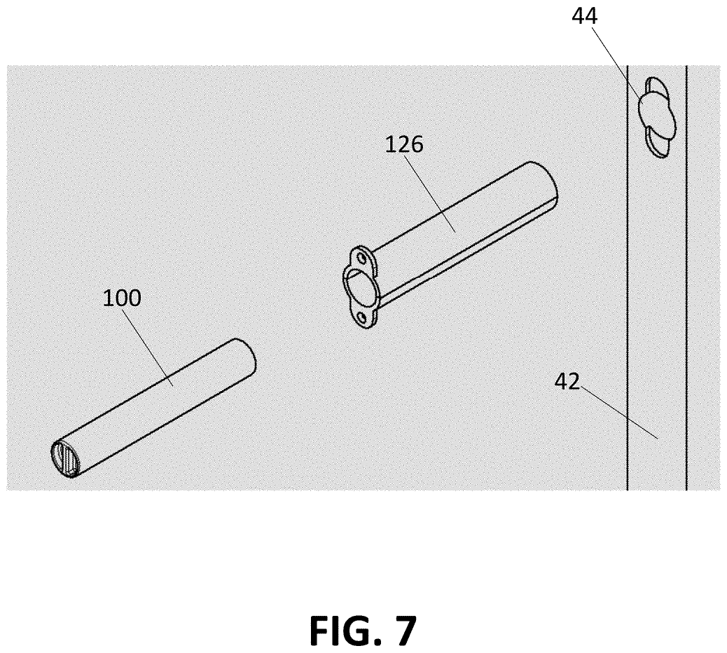

As shown in FIGS. 5 and 6, in exemplary embodiments, the battery pack 100 is inserted into an edge 42 of the door 14, for example via a lock side edge to allow for easy access to the battery pack 100. The illustrated edge 42 of the door 14, which may be formed in the frame 12, includes an opening 44 for insertion of housing 126 for the battery pack 100. The housing 126 fits into the opening 44 and is secured therein, such as with mechanical fasteners, such as screws, or adhesively. The housing 126 may also be wired to the power source 40 to allow the battery pack 100 to be electrically connected thereto. In exemplary embodiments, the battery pack 100 slides into the housing 126 and is retained therein, e.g., by one or more latches 128. To remove the battery pack 100, the user unlatches the battery pack 100 and slides it out of the housing 126. Although FIGS. 5-6 show the battery pack 100 having a rectangular shape, it may also be of different shapes, such as cylindrical as shown FIG. 7.

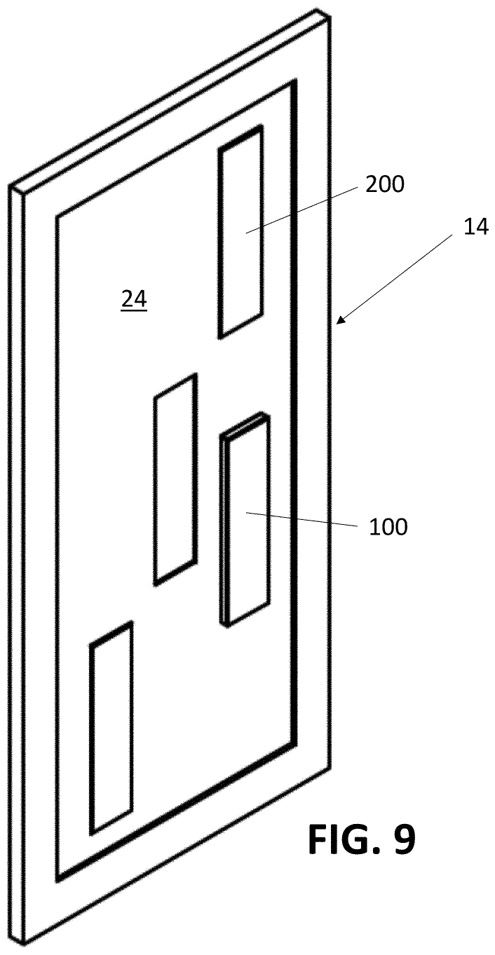

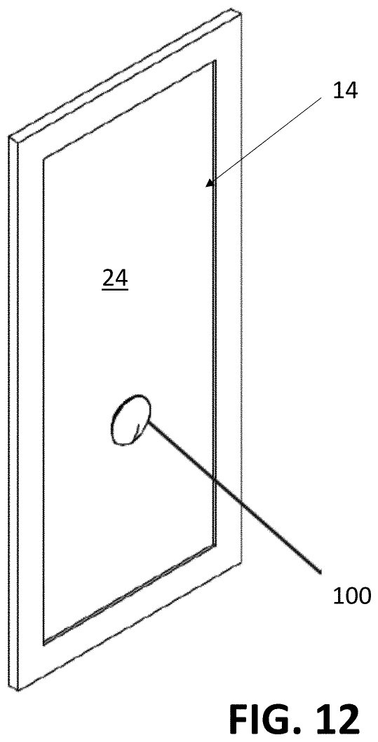

As shown in FIG. 9, in an additional exemplary embodiment, the rechargeable battery pack 100 may be attached to the interior door skin 24. In this embodiment, the battery pack may be shaped and configured to compliment the design features on the interior door skin 24. For example, as shown the FIG. 9, the door skin 24 has rectangular shaped designs 200 on its exterior surface. The illustrated rechargeable battery pack 100 also has the same rectangular shape as the designs 200 so that it blends in with the over aesthetic design of the door. Although rectangular shaped designs 200 are shown in FIG. 9, the present invention also contemplates other designs, such as a circular puck, as shown in FIG. 12.

In exemplary embodiments, the battery pack 100 may charge the internal battery 120 wirelessly or by hard wired connection. For hard wired charging, the battery pack 100 may include electrical connectors that mate to corresponding connectors on the interior door skin 24. The battery pack 100 may be attached to the exterior of the door skin 24 magnetically (using on or plural possible sets of magnets) or by one or more latches, such as a push latch, magnetically touch latch, traditional latch, or combinations thereof, and positioned proximate to the internal battery 120. Magnetic attachment provides further advantage with regard to ease of attachment and detachment of the battery pack 100 to and from the door skin 24 without requiring any tools or mechanical interfaces. In exemplary embodiments, magnetic contacts used to attach the battery pack 100 both hold the battery pack (e.g., configured as a puck) in place and act as charge terminal(s) for the battery. Battery pack 100 may be used for wireless charging, e.g., using magnetic induction or magnetic resonance, or for charging via physical connections, including wired or non-wired connections (e.g., without limitation, pogo pins or spring contacts). Additional advantages of a magnetic connection include water and dust resistance for the door and associated door system, as well as providing an overall fast mechanism for charging the internal battery.

FIG. 8 illustrates a further exemplary embodiment, which includes a charging station 102 that is similar to the charging station 102 shown in the FIG. 4 and described above. The battery pack 100 includes an input interface 300 and output power interface 302 to respectively interface with the charging station 102 and the power source 40 of the door 14. The battery pack 100 also includes a charging circuit 304 to control and regulate the charging to the battery pack 100. Alternatively, the charging circuit 304 may be located on the charging station 102 instead, as shown in FIG. 4. The battery pack 100 also includes a user interface 306 which has a low battery power indicator 308, an input power indicator 310, an output power indicator 312, and an output power button 314. The indicators 308, 310, 312, respectively indicate whether the battery pack 100 is low in power, connected to the charging station 102, and delivering charge to the internal battery 120. In certain embodiments, the user interface 306 may also include an indicator showing any fault status (not shown) for the battery pack 100. The output power button 314 allows the user to turn on/off the charging of the internal battery 120 from the battery pack 100. The output power button 314 may serve as a safety feature, e.g., when the user wishes to turn off the system when he/she leaves the premise or when there is a fault in the system. Additionally, while charging circuit 122 in the exemplary embodiment of FIG. 8 is illustrated as being within the door slab, we note that such circuit could be provided within the portable recharging puck.

As has been noted with regard to various exemplary embodiments, the battery pack 100 may be used to charge the internal battery 120 by wired connection or wirelessly. When connected by wired connection, the battery pack 100 and the internal battery 120 perform as described above for the first embodiment, except for the difference in how the battery pack 100 is connected to the door 14. The charged battery pack 100 may be inserted into the door 14 to provide DC power to the power source 40. The preferred power source 40 of the second embodiment, as shown in FIG. 8, includes an internal battery 120 that is built into the door 14 and is not easily removable. In exemplary embodiments, the battery pack 100 is attached to the door skin 24 (as aforementioned), which preferably is the door skin facing the interior of the home, building, etc. The output power interface 302 of the battery pack 100 mates (wire or wireless) with an input power interface 316 of the power source 40. In exemplary embodiments, the battery pack 100 may be attached on the interior side of the door for security reasons so that it may not be removed without approval of the user. When the battery pack 100 is low on power, the low power indicator 308 is turned on to warn the user of the low power status. The user may then remove the battery pack 100 from the door 14 and recharges it at the charging station 102. While the battery pack is being recharged, the internal battery 120 contains sufficient energy to power the door while the battery pack 100 is being recharged.

As noted above, the battery pack 100 of the second embodiment may charge the internal battery 120 wirelessly. Wireless charging is known in the art, e.g., in U.S. Pat. Nos. 9,143,000 and 8,193,764, the disclosures of which are incorporated by reference herein. Wireless charging for the present invention may be accomplished, e.g., using near field techniques, such as by inductive coupling. Wireless charging preferably involves a power transmitter (preferably in the battery pack 100) and a power receiver (preferably in the power source 40). The battery pack 100 may charge the internal battery 120 with inductive charge systems, such as through use of Qi Standard, Apple MagSafe, Magne Charge, SAE J2954 Standard, PMA Stadard, Rezence (A4WP), or the like. The power transmitter includes at least one transmitter coil and a controller for controlling the charging of the power receiver. The power receiver and the power transmitter (and thus, the battery pack 100 and the power source 40) are mounted within proximity of one another to provide effective power transmission. The proximity is generally provided by the charging standard used by the system. In exemplary embodiments, materials separating the power transmitter and the power receiver are made of electrically insulating material to minimize energy loss during wireless charging. The battery pack 100 and/or the power source 40 may also include hardware and/or software to monitor the status, to optimize/control the charge/discharging cycle, or to optimize/control the operation of the internal battery 120 and/or the battery pack 100. In exemplary embodiments, such magnetic induction is configured along with modulating data over the charging coils for a smart door system.

In other exemplary embodiments, wireless charging may be performed via magnetic resonance, which relies on the resonant frequency of the charging coils in order to create the electrical current. In exemplary embodiments, this advantageously permits multiple devices to be in the same resonant field, without relying on exact coil alignment. In further exemplary embodiments, such differing devices can have varying power requirements and varying placements along the transmission field. Further, such magnetic resonance can have longer range relative to induction, e.g., up to about 50 centimeters (cm) (versus, e.g., 15 cm for magnetic induction) and power transmission up to, e.g., 100 watts (W).

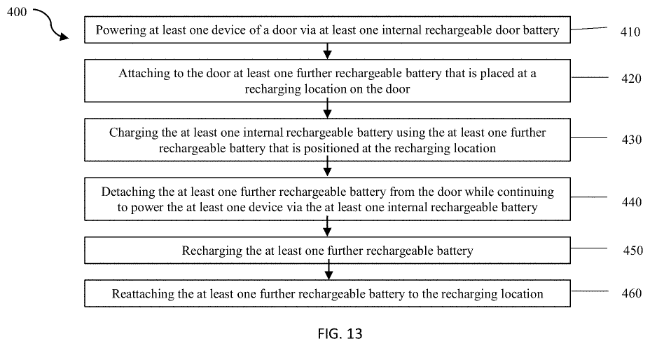

FIG. 13 provides a flowchart, generally at 400, for an exemplary methods of charging a door (in accordance with any of the various embodiments described herein) that houses a plurality of at least partially internal components, the components including plural direct current (DC) electrical devices, including at least one internal rechargeable battery and at least one device selected from the group including: an electronic access control; a door state sensor; an entry camera with video; an audio communication unit; an audio or video doorbell; a digital camera; a light; a motion detector or sensor; a proximity sensor; a door opener; heating and cooling thermostat controls; alarm sensor or controls; lighting; household or automobile batteries; or automotive controls. The method includes: at step 410, powering the at least one device via the at least one internal rechargeable battery; at step 420, attaching to the door at least one further rechargeable battery that is placed at a recharging location on the door; and at step 430, charging the at least one internal rechargeable battery using the at least one further rechargeable battery that is positioned at the recharging location. Additional steps may include at 440, detaching the at least one further rechargeable battery from the door while continuing to power the at least one device via the at least one internal rechargeable battery; at 450, recharging the at least one further rechargeable battery (e.g., externally via a wall wart or other device); and at 460, reattaching the at least one further rechargeable battery to the recharging location.

It should be understood that various aspects disclosed herein may be combined in different combinations than the combinations specifically presented in the description and accompanying drawings. It should also be understood that, depending on the example, certain acts or events of any of the processes or methods described herein may be performed in a different sequence, may be added, merged, or left out altogether (e.g., all described acts or events may not be necessary to carry out the techniques). In addition, while certain aspects of this disclosure are described as being performed by a single module or unit for purposes of clarity, it should be understood that the techniques of this disclosure may be performed by a combination of units or modules associated with, for example, a smart door.

What is claimed is:

1. A door, comprising:
a door slab, including a rectangular inner door frame;
a first facing or skin secured to or formed on a first rectangular side of the inner door frame;
a second facing or skin secured to or formed on a second, opposite rectangular side of the inner door frame;
at least one hinge portion or point of attachment configured to affix to a corresponding hinge portion or point of attachment on or within a separate outer door frame;
wherein the rectangular inner door frame includes at least one hollow cavity housing a plurality of at least partially internal components, the components including plural direct current (DC) electrical devices, including:
at least one internal rechargeable battery; and
at least one device selected from the group comprising: an electronic access control; a door state sensor; an entry camera with video; an audio communication unit; an audio or video doorbell; a digital camera; a light; a motion detector or sensor; a proximity sensor; a door opener; heating and cooling thermostat controls; alarm sensor or controls; lighting; household or automobile batteries; or automotive controls;
wherein the at least one internal rechargeable battery is configured to power the at least one device, and
wherein the at least one internal rechargeable battery is configured to be recharged by at least one further rechargeable battery that is attached to the door at a recharging location.

2. A door in accordance with claim 1, wherein the components further includes a charging circuit interposed between the at least one internal rechargeable battery and the at least one further rechargeable battery.

3. A door in accordance with claim 1, wherein the door slab includes at least one user interface or low battery notification module.

4. A door in accordance with claim 1, wherein the at least one further rechargeable battery is configured to recharge the at least one internal rechargeable battery via a magnetically mounted location, with at least one magnet positioned in the door and at least one corresponding magnet mounted in the at least one further rechargeable battery.

5. A door in accordance with claim 4, wherein plural magnets are provided within the door slab proximate a wireless recharging module in the door slab.

6. A door in accordance with claim 4, wherein the at least one further rechargeable battery is configured to recharge the at least one internal rechargeable battery via a physical connection.

7. A door in accordance with claim 6, wherein the physical connection comprises plural pogo pins or spring contacts.

8. A door in accordance with claim 6, wherein the physical connection that is configured to recharge the at least one internal rechargeable battery is also a magnetic connection configured to mount the at least one further rechargeable battery.

8. A door in accordance with claim 4, wherein the at least one further rechargeable battery is configured to wireless recharge the at least one internal rechargeable battery via an inductive or resonance charge system.

9. A door in accordance with claim 8, wherein the inductive or resonance charge system includes at least one power receiver configured to receive power from an inductive or resonant power transmitter, within a minimal proximity between the receiver and the transmitter.

10. A door in accordance with claim 9, wherein the at least one further rechargeable battery is configured to magnetically attach to the door slab to recharge the at least one internal battery.

11. A door in accordance with claim 10, wherein the at least one rechargeable battery is configured to fit in a pre-configured recess in the door slab corresponding to the shape of at least one other door or facing shape.

12. A door in accordance with claim 1, wherein the at least one further rechargeable battery is configured to recharge the at least one internal rechargeable battery at the recharging location via at least one physical connector in the door and at least one slot or interference fit mount on the at least one further rechargeable battery.

13. A door in accordance with claim 1, wherein the at least one further rechargeable battery is configured to recharge the at least one internal rechargeable battery at the recharging location via a door slab mounted recharge connector, with at least one physical connector in the door configured within at least one slot or on an interference fit mount on or within the door slab.

14. A method of charging a door, comprising:
providing a door slab provided within an external door frame, the door slab comprising:
a rectangular inner door frame;
a first facing or skin secured to or formed on a first rectangular side of the inner door frame;
a second facing or skin secured to or formed on a second, opposite rectangular side of the inner door frame;
at least one hinge portion or point of attachment configured to affix to a corresponding hinge portion or point of attachment on or within a separate outer door frame;
wherein the rectangular inner door frame includes at least one hollow cavity housing a plurality of at least partially internal components, the components including plural direct current (DC) electrical devices, including:
at least one internal rechargeable battery; and
at least one device selected from the group comprising: an electronic access control; a door state sensor; an entry camera with video; an audio communication unit; an audio or video doorbell; a digital camera; a light; a motion detector or sensor; a proximity sensor; a door opener; heating and cooling thermostat controls; alarm sensor or controls; lighting; household or automobile batteries; or automotive controls;
powering the at least one device via the at least one internal rechargeable battery;
attaching to the door at least one further rechargeable battery that is placed at a recharging location on the door; and
charging the at least one internal rechargeable battery using the at least one further rechargeable battery that is positioned at the recharging location.

15. A method in accordance with claim 1, further comprising recharging the at least one internal rechargeable battery via a magnetically mounted location, with at least one magnet positioned in the door and at least one corresponding magnet mounted in the at least one further rechargeable battery.

16. A method in accordance with claim 15, wherein plural magnets are provided within the door slab proximate a wireless recharging module in the door slab.

17. A method in accordance with claim 15, further comprising recharging the at least one internal rechargeable battery via a physical connection.

18. A method in accordance with claim 17, wherein the physical connection comprises plural pogo pins or spring contacts.

19. A method in accordance with claim 17, wherein the physical connection that is configured to recharge the at least one internal rechargeable battery is also a magnetic connection configured to mount the at least one further rechargeable battery.

20. A method in accordance with claim 15, wherein the at least one further rechargeable battery is configured to wireless recharge the at least one internal rechargeable battery via a magnetic inductive or resonance charge system.

21. A method in accordance with claim 20, wherein the magnetic inductive or resonance charge system includes at least one power receiver configured to receive power from an inductive or resonant power transmitter, within a minimal proximity between the receiver and the transmitter.

22. A method in accordance with claim 21, wherein the at least one further rechargeable battery is configured to magnetically attach to the door slab to recharge the at least one internal battery.

23. A method in accordance with claim 22, wherein the at least one rechargeable battery is configured to fit in a pre-configured recess in the door slab corresponding to the shape of at least one other door or facing shape.

24. A method in accordance with claim 14, wherein the at least one further rechargeable battery is configured to recharge the at least one internal rechargeable battery at the recharging location via at least one physical connector in the door and at least one slot or interference fit mount on the at least one further rechargeable battery.

25. A method in accordance with claim 1, wherein the at least one further rechargeable battery is configured to recharge the at least one internal rechargeable battery at the recharging location via a door slab mounted recharge connector, with at least one physical connector in the door configured within at least one slot or on an interference fit mount on or within the door slab.
